(19) United States
(12) Patent Application Publication
(10) Pub. No.: US 2025/0039783 A1
(43) Pub. Date: Jan. 30, 2025

(54) KEY DETERMINING METHOD AND APPARATUS, TERMINAL, NETWORK SIDE DEVICE, AND STORAGE MEDIUM

(71) Applicant: VIVO MOBILE COMMUNICATION CO., LTD., Guangdong (CN)

(72) Inventors: Jing LIANG, Guangdong (CN); Wei BAO, Guangdong (CN); Li CHEN, Guangdong (CN); Xuanbing LIU, Guangdong (CN)

(73) Assignee: VIVO MOBILE COMMUNICATION CO., LTD., Guangdong (CN)

(21) Appl. No.: 18/913,496

(22) Filed: Oct. 11, 2024

Related U.S. Application Data
(63) Continuation of application No. PCT/CN2023/087283, filed on Apr. 10, 2023.

(30) Foreign Application Priority Data
Apr. 12, 2022 (CN) 202210383928.7
Sep. 29, 2022 (CN) 202211204227.9

(51) Int. Cl. H04W 48/20; H04W 48/16; H04W 74/0833

(52) U.S. Cl. CPC H04W 48/20; H04W 48/16; H04W 74/0833

(57) ABSTRACT

A cell change processing method, a key determining method, an apparatus, and a device. The cell change processing method includes: in a case that a first cell meets a first condition, using, by a terminal, the first cell as a target PSCell of the terminal; and determining, by the terminal based on the first configuration, a target key for accessing the target PSCell, where the first configuration is associated with a candidate PSCell, the candidate PSCell includes the first cell, and the first configuration includes at least one of a CPC configuration or a CPA configuration.

### CROSS-REFERENCE TO RELATED APPLICATIONS

This application is a continuation of International Application No. PCT/CN2023/087283 filed on Apr. 10, 2023, which claims priority to Chinese Patent Application No. 202210383928.7 filed on Apr. 12, 2022, and to Chinese Patent Application No. 202211204227.9 filed on Sep. 29, 2022, which are incorporated herein by reference in their entireties.

### TECHNICAL FIELD

This application pertains to the field of communication technologies, and specifically, to a cell change processing method, a key determining method, an apparatus, a terminal, a network side device, and a storage medium.

### BACKGROUND

Currently, after a terminal completes one conditional primary secondary cell addition or change (CPAC) process, the terminal needs to delete a CPAC configuration. If CPAC needs to continue to be executed subsequently, a network side needs to reconfigure the CPAC configuration for the terminal. Consequently, excessive configuration overheads are caused.

### SUMMARY

According to a first aspect, a cell change processing method is provided. A terminal stores a first configuration, and the method includes:
evaluating, by the terminal, a first cell based on the first configuration;
using, by the terminal, the first cell as a target primary secondary cell (PSCell) of the terminal in a case that the first cell meets a first condition; and
determining, by the terminal based on the first configuration, a target key for accessing the target PSCell; where
the first configuration is associated with a candidate PSCell, the candidate PSCell includes the first cell, and the first configuration includes at least one of a conditional primary secondary cell change (CPC) configuration or a conditional primary secondary cell addition (CPA) configuration.

According to a second aspect, a key determining method is provided, and includes:
determining, by a secondary node (SN) based on target information, a target key currently used for and/or to be used for a first cell, where the first cell is a PSCell of a terminal; where
the target information includes at least one of the following:
indication information of a master node (MN); or
information carried when the terminal performs random access.

According to a third aspect, a key determining method is provided, and includes:
determining, by a master node MN, a target key currently used for and/or to be used for a first cell, where the first cell is a primary secondary cell PSCell of a terminal; and
sending, by the MN, the target key to a secondary node SN.

According to a fourth aspect, a cell change processing apparatus is provided. The apparatus stores a first configuration, and the apparatus includes:
an evaluation module, configured to evaluate a first cell based on the first configuration;
a first determining module, configured to use the first cell as a target PSCell of a terminal in a case that the first cell meets a first condition; and
a second determining module, configured to determine, based on the first configuration, a target key for accessing the target PSCell; where
the first configuration is associated with a candidate PSCell, the candidate PSCell includes the first cell, and the first configuration includes at least one of a conditional primary secondary cell change CPC configuration or a conditional primary secondary cell addition CPA configuration.

According to a fifth aspect, a key determining apparatus is provided, and includes:
a determining module, configured to determine, based on target information, a target key currently used for and/or to be used for a first cell, where the first cell is a primary secondary cell PSCell of a terminal; where
the target information includes at least one of the following:
indication information of a master node MN; or
information carried when the terminal performs random access.

According to a sixth aspect, a key determining apparatus is provided, and includes:
a determining module, configured to determine a target key currently used for and/or to be used for a first cell, where the first cell is a primary secondary cell PSCell of a terminal; and
a first sending module, configured to send the target key to a secondary node SN.

According to a seventh aspect, a terminal is provided. The terminal includes a processor and a memory, the memory stores a program or an instruction that can be run on the processor, and when the program or the instruction is executed by the processor, the steps of the cell change processing method according to an embodiment of this application are implemented.

According to an eighth aspect, a terminal is provided, and includes a processor and a communication interface. The processor is configured to: evaluate a first cell based on a first configuration; use the first cell as a target PSCell of the terminal in a case that the first cell meets a first condition; and determine, based on the first configuration, a target key for accessing the target PSCell, where the first configuration is associated with a candidate PSCell, the candidate PSCell includes the first cell, and the first configuration includes at least one of a conditional primary secondary cell change CPC configuration or a conditional primary secondary cell addition CPA configuration.

According to a ninth aspect, a network node is provided. The network node is an SN and includes a processor and a memory, the memory stores a program or an instruction that can be run on the processor, and when the program or the instruction is executed by the processor, the steps of the key determining method on an SN side according to an embodiment of this application are implemented.

According to a tenth aspect, a network node is provided. The network node is an SN and includes a processor and a communication interface, the processor is configured to determine, based on target information, a target key currently used for and/or to be used for a first cell, where the first cell is a primary secondary cell PSCell of a terminal, and the target information includes at least one of the following: indication information of an MN, or information carried when the terminal performs random access.

According to an eleventh aspect, a network node is provided. The network node is a master node MIN and includes a processor and a memory, the memory stores a program or an instruction that can be run on the processor, and when the program or the instruction is executed by the processor, the steps of the key determining method on an NIN side according to an embodiment of this application are implemented.

According to a twelfth aspect, a network node is provided. The network node is an MN and includes a processor and a communication interface. The processor is configured to determine a target key currently used for and/or to be used for a first cell, where the first cell is a primary secondary cell PSCell of a terminal. The communication interface is configured to send the target key to a secondary node SN.

According to a thirteenth aspect, a resource determining system is provided, and includes a terminal, an SN, and an NIN. The terminal may be configured to perform the steps of the cell change processing method according to the first aspect, the SN may be configured to perform the steps of the key determining method according to the second aspect, and the MN may be configured to perform the steps of the key determining method according to the third aspect.

According to a fourteenth aspect, a readable storage medium is provided. The readable storage medium stores a program or an instruction, and when the program or the instruction is executed by a processor, the steps of the cell change processing method according to an embodiment of this application are implemented, or the steps of the key determining method on an SN side according to an embodiment of this application are implemented, or the steps of the key determining method on an MN side according to an embodiment of this application are implemented.

According to a fifteenth aspect, a chip is provided. The chip includes a processor and a communication interface. The communication interface is coupled to the processor. The processor is configured to run a program or an instruction, to implement the steps of the method according to the first aspect, the steps of the method according to the second aspect, or the steps of the method according to the third aspect.

According to a sixteenth aspect, a computer program/program product is provided. The computer program/program product is stored in a storage medium, and the computer program/program product is executed by at least one processor to implement the steps of the cell change processing method according to an embodiment of this application, or the computer program/program product is executed by at least one processor to implement the steps of the key determining method on an SN side according to an embodiment of this application, or the computer program/program product is executed by at least one processor to implement the steps of the key determining method on an MN side according to an embodiment of this application.

### BRIEF DESCRIPTION OF DRAWINGS

FIG. 1 is a block diagram of a wireless communication system to which embodiments of this application are applicable;

FIG. 2 is a schematic diagram of a cell change processing method according to an embodiment of this application;

FIG. 3 is a flowchart of a key determining method according to an embodiment of this application;

FIG. 4 is a flowchart of another key determining method according to an embodiment of this application;

FIG. 5 is a structural diagram of a cell change processing apparatus according to an embodiment of this application;

FIG. 6 is a structural diagram of a key determining apparatus according to an embodiment of this application;

FIG. 7 is a structural diagram of another key determining apparatus according to an embodiment of this application;

FIG. 8 is a structural diagram of a communication device according to an embodiment of this application;

FIG. 9 is a structural diagram of a terminal according to an embodiment of this application; and

FIG. 10 is a structural diagram of a network node according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the term NR is used in most of the following description, although these technologies can also be applied to applications other than the NR system application, such as the 6th generation (6G) communication system.

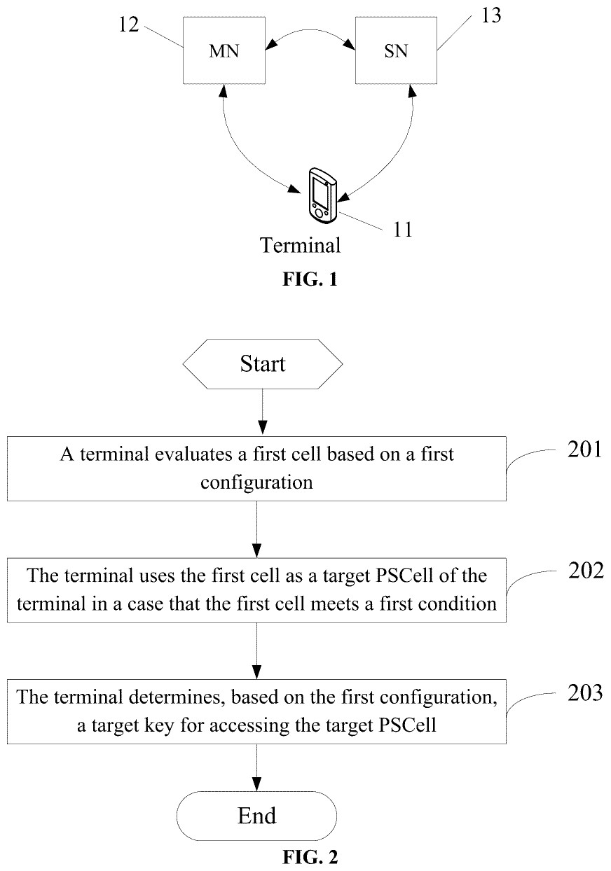

FIG. 1 is a block diagram of a wireless communication system to which the embodiments of this application may be applied. The wireless communication system includes a terminal 11, an MN 12, and an SN 13. The terminal 11 may be a terminal side device such as a mobile phone, a tablet personal computer, a laptop computer that is also referred to as a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with a wireless communication function, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application.

The MN 12 and the SN 13 may include an access network device and a core network device. The access network device may also be referred to as a radio access network device, a radio access network (RAN), a radio access network function, or a radio access network unit. The access network device may include a base station, a wireless local area network (WLAN) access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another proper term in the art. The base station is not limited to a specific technical term provided that a same technical effect is achieved. It should be noted that in the embodiments of this application, a base station in an NR system is merely used as an example for description, but does not limit a specific type of the base station.

In addition, in this embodiment of this application, the MN 12 and the SN 13 may be an MN and an SN that are provided for the terminal in a dual connectivity (DC) scenario. A carrier aggregation (CA) technology is used at each network node, that is, a series of serving cells controlled by the node are configured for a terminal, and the series of serving cells are also referred to as a cell group. A cell group controlled by the MN is a master cell group (MCG), and a cell group controlled by the SN is a secondary cell group (SCG). Each cell group includes a special cell (SpCell) and a series of secondary cells (Scell). In the MCG, the special cell is referred to as a primary cell (PCell), and in the SCG, the special cell is referred to as a primary secondary cell (PSCell). In one cell group, the SpCell uses a main carrier, while another secondary cell uses a secondary carrier, and resource scheduling in one cell group is carried out by the SpCell.

In the embodiments of this application, a CPAC process may include CPA and CPC.

CPA is primary secondary cell addition executed by the terminal after the terminal evaluates an execution condition and the execution condition is met.

A CPA configuration may include a configuration and an execution condition of a CPA candidate cell. The execution condition may include one or more triggering conditions.

CPC is primary secondary cell change executed by the terminal after the terminal evaluates an execution condition and the execution condition is met. After receiving a CPC configuration, the terminal starts to evaluate the execution condition. After the primary secondary cell change is triggered, the terminal stops evaluating the execution condition.

The CPC configuration may include a configuration and an execution conditions of a CPC candidate cell. The execution condition possibilities include one or more triggering conditions.

CPC includes a plurality of scenarios, which may include at least one of the following:
intra-secondary node conditional primary secondary cell change (Intra-SN CPC);
master node initiated inter-secondary node conditional primary secondary cell change (MN initiated Inter-SN CPC); or
secondary node initiated inter-secondary node conditional primary secondary cell change (SN initiated Inter-SN CPC).

A cell change processing method, a key determining method, an apparatus, and a device that are provided in the embodiments of this application are described in detail below with reference to the accompanying drawings by using specific embodiments and application scenarios thereof.

FIG. 2 is a flowchart of a cell change processing method according to an embodiment of this application. As shown in FIG. 2, the method includes the following steps:

Step 201: A terminal evaluates a first cell based on a first configuration.

The terminal stores the first configuration.

The first configuration is associated with a candidate PSCell, the candidate PSCell includes the first cell, and the first configuration includes at least one of a CPC configuration or a CPA configuration.

That the terminal stores the first configuration may be understood as follows: After the terminal releases the first cell, the terminal stores the first configuration; or the terminal camps on the first cell, and after releasing the first cell, the terminal stores the first configuration. Alternatively, the terminal stores the first configuration before step 201 is performed. For example, before performing step 201, the terminal has executed CPC or CPA by using the configuration.

In some implementations, step 201 may be: After the terminal releases the first cell, or after the terminal camps on the first cell and then releases the first cell, the terminal evaluates the first cell based on the first configuration. Alternatively, step 201 may be: Evaluate the first cell for the first time by using the first configuration.

In some implementations, the first configuration may be: receiving a CPA or CPC configuration message sent by a network side, and the configuration includes security-related configurations of a plurality of candidate PSCells. In this embodiment of this application, the first configuration may also be referred to as a CPAC configuration.

In some implementations, the first configuration includes at least one of the following:
a condition reconfiguration; or
an execution condition.

The condition reconfiguration includes at least one of the following:
a candidate SCG used for CPAC; or
one or more counter values.

In some implementations, each PSCell may be associated with one or more counter values, and these counter values are used to determine a key.

In this embodiment of this application, the counter value may be a counter (sk-counter) value or an SN counter value used to calculate a key.

It should be noted that in this embodiment of this application, the counter value may also be referred to as a counter.

In some implementations, the first configuration may be a configuration indicated by a radio resource control (RRC) reconfiguration message.

Step 202: The terminal uses the first cell as a target PSCell of the terminal in a case that the first cell meets a first condition.

The first condition is a condition associated with the first configuration, for example, the execution condition included in the first configuration, such as an execution condition for CPC or an execution condition for CPA.

That the terminal uses the first cell as the target PSCell of the terminal may be: performing a CPC or CPA process for the first cell. For example, the first cell may be used as the target PSCell of the terminal for the first time, or before step 202, the terminal uses the first cell as the target PSCell of the terminal, but subsequently changes or releases the first cell.

Step 203: The terminal determines, based on the first configuration, a target key for accessing the target PSCell.

The determining, based on the first configuration, a target key for accessing the target PSCell may be: determining a primary key or a secondary key corresponding to the first configuration.

In this embodiment of this application, by using the foregoing steps, the terminal may select the first cell as the target PSCell of the terminal based on the stored first configuration, and determine the target key for accessing the target PSCell, so that it is not necessary to obtain a CPAC configuration reconfigured by network side each time CPAC is executed, thereby reducing configuration overheads.

In an optional implementation, the first cell is a cell that has been released by the terminal, or the first cell is a cell on which the terminal has camped or a cell that has been accessed by the terminal.

In this implementation, in a case that the first cell or the cell on which the terminal has previously camped on has been released, the terminal may select the first cell again as the target PSCell of the terminal based on the stored first configuration, so that only one first configuration needs to be configured for the terminal, thereby saving configuration overheads. For example, after the terminal uses the first cell as the PScell based on the first configuration, the PScell changes from the first cell to a second cell, and then the terminal changes the PScell to the first cell based on the first configuration.

In an optional implementation, before the terminal uses the first cell as the target PSCell of the terminal, the PSCell of the terminal changes from the first cell to another cell; or
before the terminal uses the first cell as the target PSCell of the terminal, the terminal releases the first cell used as a PSCell of the terminal.

That the PSCell of the terminal changes from the first cell to the another cell may be that the PSCell of the terminal changes from the first cell for one or more times. For example, the PSCell of the terminal changes from the first cell to the second cell, then changes from the second cell to the another cell, and then changes from the another cell to the first cell. Alternatively, the PSCell of the terminal changes from the first cell to the second cell, and then changes from the second cell to the first cell.

That the terminal releases the first cell used as the PSCell of the terminal may be that the terminal uses the first cell as the PSCell of the terminal through CPA or CPC, and then the terminal releases the first cell.

Optionally, that the terminal uses the first cell as the target PSCell of the terminal includes:
the terminal changes the target PSCell of the terminal to the first cell in a case that the PSCell of the terminal changes from the first cell to another cell; or
the terminal adds the first cell as the target PSCell of the terminal.

That the terminal adds the first cell as the target PSCell of the terminal may be: the PSCell of the terminal changes from the first cell to another cell, or in a case that the terminal releases the first cell, the first cell is added as the target PSCell of the terminal.

In this implementation, the first cell may be used as the target PSCell of the terminal through CPA or CPC.

In an optional implementation, the target key is a first key, the first key is different from a second key, and the second key is a key used by the terminal for the first cell before the terminal uses the first cell as the target PSCell of the terminal.

In this implementation, because the second key is a key used by the terminal for the first cell before the terminal uses the first cell as the target PSCell of the terminal, different keys can be used each time the terminal accesses the first cell, thereby improving security.

Optionally, the first key is a first secondary key, and the second key is a second secondary key; or
the first key is a primary key, and the second key is a secondary key; or
the first key is a secondary key, and the second key is a primary key.

The first secondary key and the second secondary key are two different secondary keys, and may be specifically secondary keys calculated based on different counter values.

The primary key may be a key corresponding to an MCG bearer.

In this implementation, because the first key is a primary key and the second key is a secondary key, or the first key is a secondary key and the second key is a primary key, it can be ensured that when different keys are used each time the first cell is accessed, and further, the primary key may be used to access the PSCell, to further improve security of accessing the PSCell.

Optionally, the first configuration includes a plurality of counter values associated with the first cell, the first secondary key is a secondary key calculated based on one counter value in the plurality of counter values, and the second secondary key is a secondary key calculated based on another counter value in the plurality of counter values.

In this implementation, different secondary keys may be calculated by using different counter values, to ensure that different keys are used each time the terminal accesses the first cell, thereby improving security.

Optionally, the first secondary key is a secondary key calculated based on a first counter value in the plurality of counter values, and the second secondary key is a secondary key calculated based on a second counter value in the plurality of counter values. The first counter value is located after the second counter value in a target sequence, and the target sequence is a sequence of the plurality of counter values.

That the first counter value is located after the second counter value in the target sequence may be understood as: The terminal sequentially uses counter values in the plurality of counter values in the target sequence.

For example, the target sequence is: counter value A-counter value B-counter value C-counter value D. In this case, when the second counter value is the counter value A, the first counter value is the counter value B; when the second counter value is the counter value B, the first counter value is the counter value C; and when the second counter value is the counter value C, the first counter value is the counter value D.

In this implementation, because the terminal sequentially uses the counter values in the plurality of counter values in the target sequence to calculate the secondary key, it is easier for the terminal and a network side to directly and accurately determine a secondary key used each time and to have consistent understanding.

Optionally, the target sequence is an ascending sequence of the plurality of counter values; or
the target sequence is a descending sequence of the plurality of counter values; or
the target sequence is a sequence of the plurality of counter values that is indicated by the first configuration.

In this implementation, when changing the target PSCell to the first cell, the terminal may sequentially use the counter values in an ascending sequence or a descending sequence.

For example, in the case of an ascending sequence, when the terminal accesses the first cell for the first time (for example, adding the first cell as the PSCell or changing from another cell to the first cell), a counter value x is used; when the terminal accesses the first cell for the second time, a counter value y is used; and in the third time, a counter value z is used, where counter value x<counter value y<counter value z, and the counter value x that is used first needs to be a minimum value in the plurality of counter values.

For example, in the case of a descending sequence, when the terminal accesses the first cell for the first time, a counter value z is used; when the terminal accesses the first cell for the second time, a counter value y is used; and in the third time, a counter value x is used, where counter value x<counter value y<counter value z, and the counter value z that is used first needs to be a maximum value in the plurality of counter values.

The sequence of the plurality of counter values that is indicated by the first configuration may be a sequence of the plurality of counter values that is explicitly or implicitly indicated by the first configuration. For example, in a case that the target sequence is the sequence of the plurality of counter values that is indicated by the first configuration,
the first configuration carries sequence indication information, and the sequence indication information is used to indicate the target sequence; or
the target sequence is a sequence in which the plurality of counter values are carried in the first configuration.

For example, the plurality of counter values in the first configuration additionally carry, in the configuration, a configuration of a sequence of using the plurality of counter values, and a string may identify an indication of a sequence of different counter values.

For example, in the case of an implicit indication, the target sequence is the sequence in which the counter values are carried in the configuration. For example, in the first configuration, a counter value at a first entry is used first, a counter value at a second entry is used secondly, and the like.

It should be noted that, in this embodiment of this application, the plurality of counter values are not limited to be used on the target sequence. For example, in some implementations, another sequence may be used, or the plurality of counter values may be used randomly.

Optionally, the method further includes at least one of the following:
deleting, by the terminal, the first configuration in a case that all counter values in the first configuration have been used; or
in a case that all counter values in the first configuration have been used, deleting, by the terminal, the first cell from the candidate PSCell, or skipping, by the terminal, evaluation in terms of the first condition on the first cell.

The foregoing deleting the configuration and the first cell may be: deleting the configuration and the first cell when the PSCell of the terminal changes to the first cell, deleting the configuration and the first cell when the PSCell of the terminal changes from the first cell to another cell, or deleting the configuration and the first cell when the first cell is released.

In this implementation, the first configuration is deleted in a case that all counter values in the first configuration have been used. In this way, the following problem can be avoided: because there is no available counter value when the first configuration is subsequently used to evaluate a cell, change or addition of the PSCell fails.

In this implementation, in a case that all counter values in the first configuration have been used, the first cell is deleted from the candidate PSCell, or evaluation in terms of the first condition is not performed on the first cell. In this way, the following problem can be prevented: because there is no available counter value when the first configuration is subsequently used to evaluate the first cell, change or addition of the PSCell fails.

Optionally, the first configuration further includes a configuration associated with the second cell, and the method further includes:
deleting, by the terminal, the configuration associated with the second cell from the first configuration in a case that all counter values associated with the second cell that are included in the first configuration have been used.

That the first configuration further includes a configuration associated with the second cell may be that the first configuration may include configurations associated with a plurality of cells and the second cell may be any cell. In this way, in a case that a counter value associated with any cell has been used, a configuration associated with the cell can be deleted from the first configuration, to avoid a problem that change or addition of the PSCell fails when the first configuration is still used to evaluate the cell.

Optionally, the method further includes at least one of the following:
deleting, by the terminal, a counter value that has been used from the first configuration; or
deleting, by the terminal, a secondary key that has been used.

That the terminal deletes the counter value that has been used from the first configuration may be that after calculating a secondary key based on a specific counter value, the terminal deletes the counter value.

The deleting a secondary key that has been used may be: after a specific secondary key is used to access the PSCell, the secondary key is deleted; or may be: after a specific secondary key is used to access the PSCell, the secondary key is deleted during change or addition of the PSCell.

In this implementation, the counter value that has been used is deleted, and the secondary key that has been used is deleted. In this way, a same secondary key can be prevented from being subsequently calculated, to ensure that a new key is used each time, thereby improving security.

Optionally, the deleting, by the terminal, a used secondary key that has been used includes: removing, by the terminal, the secondary key that has been used from a local variable, where the local variable is a local variable corresponding to the first configuration.

In this implementation, implementation may be implemented based on the local variable, and a used secondary key is deleted each time after the secondary key is used, to ensure that a latest key is used each time, so as to improve security.

For example, the terminal receives a reconfiguration message sent by a network side, where the message includes N counter values; the terminal locally maintains a variable, where a variable name is, for example, VarCondReconfigKeyList, and stores the N counter values or a secondary key calculated based on the N counter values; the terminal may generate one variable for each PSCell or one variable for all PSCells; then, when the terminal executes CPC for the first time, it is assumed that a secondary key 1 derived from a counter value 1 is used; after the secondary key 1 is used, the counter value 1 in variables or the secondary key 1 calculated based on the counter value 1 is deleted, and a new secondary key is used during subsequent execution of CPC.

Optionally, the first configuration includes a first counter value associated with the first cell, the first secondary key is a secondary key calculated based on a second counter value, the second counter value is a counter value obtained by adding M to a counter value corresponding to the second secondary key, and the counter value corresponding to the second secondary key includes:
the first counter value, or a counter value obtained after adding N to the first counter value; where
M is an integer greater than or equal to 0, and N is an integer greater than or equal to 1.

The first counter value is one counter value.

The foregoing values of N and M may be defined in a protocol, or may be configured on the network side. In some implementations, the foregoing values of N and M may be alternatively determined by the terminal.

The first secondary key may be calculated during access to the first cell, or may be calculated after the second secondary key is used. This is not limited herein.

That the counter value corresponding to the second secondary key includes the first counter value may be understood as that the second secondary key is a key used by the terminal to access the first cell for the first time. That the counter value corresponding to the second secondary key includes the counter value obtained after adding N to the first counter value may be understood as that the second secondary key may be a key used by the terminal to access the first cell for the second time, the third time, or for more times.

In this implementation, based on the first counter value, each time the first cell is accessed, the secondary key may be calculated by using different values, to reduce overheads of the first configuration, because there is no need to configure a plurality of counter values.

For example, the terminal performs evaluation based on the first configuration. When the terminal needs to change to a new PSCell, a counter value in the first configuration is first used, and N is added to the counter value after a new secondary key is calculated or before a new key is calculated next. A new secondary key is calculated based on a new counter value in each subsequent time, and the new counter value is reported to the MN, or the MN learns a handover status of the terminal based on uplink information (UL information) reported by UE, and obtains a latest value of the counter value, and continues to add N to the counter value.

Optionally, the first configuration further includes a maximum quantity of times of changing the PSCell based on the first configuration, or a maximum quantity of times of using the first counter value or a maximum value of the first counter value.

In this way, a problem that security is reduced because the terminal changes the PSCell for excessive times by using the first configuration can be avoided.

Optionally, in a case that the first secondary key is the secondary key calculated based on the second counter value, the method further includes:
reporting, by the terminal, at least one of the following to a network node:
the second counter value or the secondary key calculated based on the second counter value;
a quantity of times of using the first cell as the PSCell based on the first configuration; or
a quantity of times of performing a conditional primary secondary cell addition or change CPAC process based on the first configuration.

The quantity of times of using the first cell as the PSCell based on the first configuration may be used by the network node to calculate a key currently used by the terminal. The quantity of times of performing the CPAC process based on the first configuration may also be used by the network node to calculate the key currently used by the terminal. For example, based on the quantity of times of performing the CPAC process, the network node may add a corresponding value to the counter value to obtain a counter value currently used by the terminal, and further calculate a corresponding key.

In this implementation, the network node may be an MN. Certainly, this is not limited. For example, in some implementations, the network node may be alternatively an SN.

In this implementation, at least one of the foregoing items may be reported, so that the network node obtains a prepared key to communicate with the terminal, thereby avoiding occurrence of a communication error.

In an optional implementation, the method further includes:
reporting, by the terminal, notification information to the network node, where the notification information includes at least one of the following:
a quantity of times that the terminal performs the CPAC process for the first cell;
duration of the CPAC process performed by the terminal for the first cell;
a quantity of times of performing the CPAC process based on the first configuration; or
duration of the CPAC process performed based on the first configuration.

The quantity of times of performing the CPAC process and the duration of performing the CPAC process may be a quantity of times and duration of performing CPAC processes corresponding to all cells by the terminal based on the first configuration.

The reporting, by the terminal, notification information to the network node may include:
reporting, by the terminal, the notification information to the network node in a random access message or a radio resource control (RRC) message.

In some implementations, the notification information may be alternatively reported to the network node by using a random access message.

The network node may be an SN. Certainly, in some implementations, the network node may be alternatively an MN.

The notification information is used by the network node to determine whether to initiate a key change. For example, in a case that the quantity of times of the CPAC process reaches a threshold or the duration reaches a threshold, the network node determines to initiate a key change, so that the SN sends the key change indication to the MN, to update the key, thereby improving security.

In this embodiment of this application, a terminal stores a first configuration, and the terminal evaluates a first cell based on the first configuration; the terminal uses the first cell as a target PSCell of the terminal in a case that the first cell meets a first condition; and the terminal determines, based on the first configuration, a target key for accessing the target PSCell. The first configuration is associated with a candidate PSCell, the candidate PSCell includes the first cell, and the first configuration includes at least one of a conditional primary secondary cell change CPC configuration or a conditional primary secondary cell addition CPA configuration. In this way, the terminal may select the first cell as the target PSCell of the terminal based on the stored first configuration, and determine the target key for accessing the target PSCell. Therefore, it is not necessary to obtain a CPAC configuration reconfigured by network side each time CPAC is executed, thereby reducing configuration overheads.

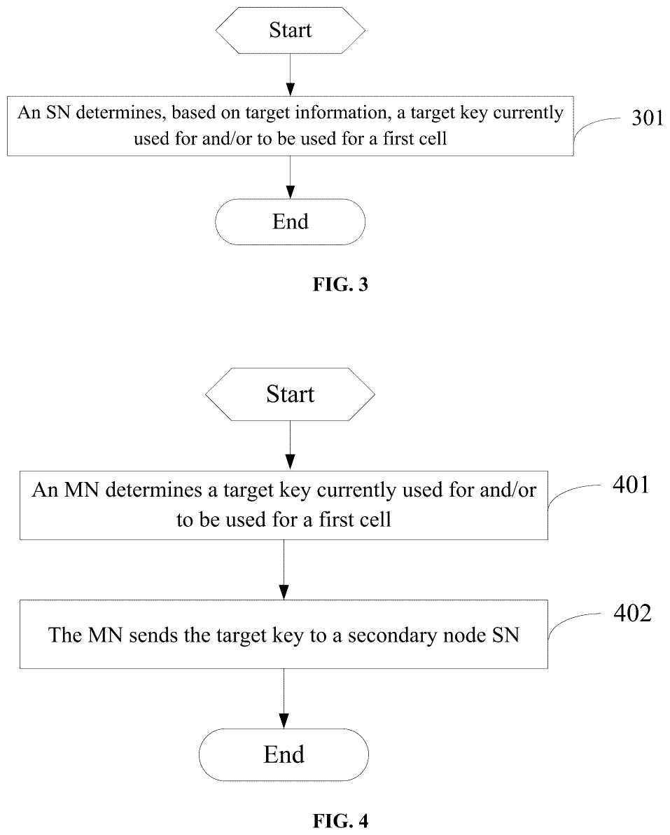

FIG. 3 is a flowchart of a key determining method according to an embodiment of this application. As shown in FIG. 3, the method includes the following steps:

Step 301: An SN determines, based on target information, a target key currently used for and/or to be used for a first cell, where the first cell is a PSCell of a terminal.

The target information includes at least one of the following:
indication information of a master node MN; or
information carried when the terminal performs random access.

The target key currently used for the first cell may be a key used for current access.

The indication information of the NIN may be indication information used to indicate the target key, or the indication information is the target key.

The information carried when the terminal performs random access may include at least one of the following:
a quantity of CPAC times, CPAC duration, a counter value.

The quantity of CPAC times may be a quantity of times that the terminal performs a CPAC process for the first cell, and/or a quantity of times that the terminal performs the CPAC process based on the first configuration. The CPAC duration may be duration in which the terminal performs the CPAC process for the first cell, and/or duration in which the CPAC process is performed based on the first configuration.

In this embodiment, the target key currently used for and/or to be used for the first cell can be accurately determined, to support the terminal in accessing the first cell based on a configuration for a plurality of times, thereby reducing configuration overheads.

Optionally, the method further includes:
the SN releases at least one of the following in a case that all target keys associated with the terminal have been used:
context of the terminal;
a connection to a master node NIN of the terminal; or
a connection to the terminal; and
the SN maintains at least one of the following in a case that there is still an unused target key in keys associated with the terminal:
context of the terminal;
a connection to an MN of the terminal; or
a connection to the terminal.

That the target key has been used means that access by the terminal is completed based on the target key and communication is performed with the terminal based on the target key. For example, when sending the counter value to the terminal for the first time, the MN also sends one or more secondary keys (for example, secondary keys 1 and 2) to the SN. The terminal calculates the secondary key 1 based on the counter value and uses the secondary key 1 to perform access, and later calculates the secondary key 2 based on a new counter value and uses the secondary key 2 to perform access. When the terminal accesses the SN and both the terminal and the SN perform communication based on the secondary keys 1 and 2, that is, both the secondary keys 1 and 2 are used, this means that the secondary keys 1 and 2 have been used.

In this implementation, in a case that all the target keys associated with the terminal have been used, the SN releases the context of the terminal, the connection to the MN of the terminal, and the connection to the terminal, so that resource overheads can be reduced; and in a case that there is still an unused target key in the keys associated with the terminal, the SN maintains the context of the terminal, the connection to the MN of the terminal, and the connection to the terminal, so that the terminal can be supported in accessing the first cell based on the first configuration again, to reduce configuration overheads.

In an optional implementation, the indication information of the MN includes:
the target key, where the target key is a key calculated by the MN based on reported information of the terminal; or
a key carried in the reported information of the terminal.

Optionally, the reported information of the terminal includes at least one of the following:
a second counter value or a secondary key calculated based on the second counter value, where the second counter value is a counter value calculated by the terminal based on a first counter value included in a first configuration, the first configuration is associated with a candidate PSCell, and the first configuration includes at least one of a conditional primary secondary cell change CPC configuration or a conditional primary secondary cell addition CPA configuration;
a quantity of times that the terminal uses the first cell as the PSCell based on the first configuration; or
a quantity of times that the terminal performs a conditional primary secondary cell addition or change CPAC process based on the first configuration.

In this implementation, in a case that the first configuration includes one counter value, the MN calculates the currently used target key based on information reported by the terminal.

Optionally, the method further includes:
the network node receives notification information reported by the terminal; and
the network node sends a key change indication to the MN of the terminal based on the notification information; where
the notification information includes at least one of the following:
a quantity of times that the terminal performs the CPAC process for the first cell;
duration of the CPAC process performed by the terminal for the first cell;
a quantity of times of performing the CPAC process based on the first configuration; or
duration of the CPAC process performed by the terminal based on the first configuration.

The notification information is used by the network node to determine whether to initiate a key change. For example, in a case that the quantity of times of the CPAC process reaches a threshold or the duration reaches a threshold, the network node determines to initiate a key change, so that the SN sends the key change indication to the MN, to update the key, thereby improving security.

Optionally, the target key is a first key, the first key is different from a second key, and the second key is a key used by the SN for the first cell before the terminal uses the first cell as a target PSCell of the terminal.

For example, the second key is a key used by the SN to communicate with the terminal in the first cell before the terminal uses the first cell as the target PSCell of the terminal.

Optionally, the first key is a first secondary key, and the second key is a second secondary key; or
the first key is a primary key, and the second key is a secondary key; or
the first key is a secondary key, and the second key is a primary key.

Optionally, the method further includes:
the SN receives a configuration that is sent by the MN and that includes a plurality of counter values or a plurality of keys associated with the first cell.

The case that the configuration includes the plurality of keys may mean that the NIN calculates the plurality of keys based on the plurality of counter values, and sends the plurality of keys to the SN. The case that the configuration includes the plurality of counter values may mean that the SN calculates the plurality of keys based on the plurality of counter values.

The configuration may be a CG configuration.

Optionally, the first secondary key and the second secondary key are keys in the plurality of keys; and
the first secondary key is located after the second secondary key in a target sequence, and the target sequence is a sequence of the plurality of keys.

In the foregoing implementation, after the SN receives, from the MN, the configuration that is associated with the target cell association and that includes the plurality of keys, the SN can sequentially use an X^{th} key to communicate with the terminal when the terminal switches to/selects the target cell as a serving PSCell for an X^{th} time.

Optionally, the target sequence is an ascending sequence of the plurality of keys; or
the target sequence is a descending sequence of the plurality of keys; or
the target sequence is a sequence of the plurality of keys that is indicated by the configuration.

Optionally, in a case that the target sequence is the sequence of the plurality of keys that is indicated by the configuration,
the configuration carries sequence indication information, and the sequence indication information is used to indicate the target sequence; or
the target sequence is a sequence in which the plurality of key are carried in the configuration.

In a case that a sequence of the plurality of keys is indicated in the configuration, the sequence of these keys may be indicated based on a plurality of counter values. For example, the MN indicates the plurality of keys in an ascending sequence of the counter values, that is, a smaller counter value corresponding to a key leads to a higher ranking of the key, and a larger counter value corresponding to a key leads to a lower ranking of the key. For another example, the MN indicates the plurality of keys in a descending sequence of the counter values, that is, a larger counter value corresponding to a key leads to a higher ranking of the key, and a smaller counter value corresponding to a key leads to a lower ranking of the key.

Alternatively, in a case that the sequence of the plurality of keys is indicated in the configuration, the sequence of the plurality of keys may be determined by the MN.

It should be noted that this embodiment is used as an implementation of the SN corresponding to the embodiment shown in FIG. 2. For a specific implementation of this embodiment, reference may be made to related descriptions of the embodiment shown in FIG. 2. To avoid repetition, details are not described in this embodiment.

FIG. 4 is a flowchart of another key determining method according to an embodiment of this application. As shown in FIG. 4, the method includes the following steps:

Step 401: An MN determines a target key currently used for and/or to be used for a first cell, where the first cell is a PSCell of a terminal.

Step 402: The MN sends the target key to a secondary node SN.

The target key that is determined by the MN and that is currently used for and/or to be used for the first cell may be a target key determined based on reported information of the terminal, or a target key that is determined based on an agreement in a protocol and that is currently used for the first cell. This is not specifically limited.

In this embodiment, the target key currently used for the first cell may be sent to the SN, to support the terminal in accessing the first cell based on a configuration for a plurality of times, thereby reducing configuration overheads.

Optionally, the method further includes:
the MN sends a first configuration to the terminal, where the first configuration includes at least one of the following:
a plurality of counter values corresponding to a plurality of target keys; or
first counter values corresponding to one or more target keys; where
the plurality of target keys are a plurality of target keys that are determined by the MN and that are used by the terminal for the first cell; and
the first configuration is associated with a candidate PSCell, and the first configuration includes at least one of a conditional primary secondary cell change CPC configuration or a conditional primary secondary cell addition CPA configuration.

Optionally, that the MN determines a target key currently used for and/or to be used for the first cell includes:
calculating, by the MN based on reported information of the terminal, the target key currently be used for the first cell; or
obtaining the target key from the reported information of the terminal.

Optionally, the reported information of the terminal includes at least one of the following:
a second counter value or a secondary key calculated based on the second counter value, where the second counter value is a counter value calculated by the terminal based on a first counter value includes in the first configuration, the first configuration is associated with a candidate PSCell, and the first configuration includes at least one of a conditional primary secondary cell change CPC configuration or a conditional primary secondary cell addition CPA configuration;
a quantity of times that the terminal uses the first cell as a PSCell based on the first configuration; or
a quantity of times that the terminal performs a conditional primary secondary cell addition or change CPAC process based on the first configuration.

It should be noted that this embodiment is used as an implementation of the MN corresponding to the embodiment shown in FIG. 2. For a specific implementation of this embodiment, reference may be made to related descriptions of the embodiment shown in FIG. 2. To avoid repetition, details are not described in this embodiment.

The method provided in embodiments of this application is described as examples below by using a plurality of embodiments:

### Embodiment 1

This embodiment is mainly described by using an example in which counter values are successively used, and may include the following steps:

Step 1: A base station sends a CPA or CPC configuration message to a terminal, where for each candidate PSCell, the base station may obtain a security-related configuration in advance.

Optionally, a CPAC configuration in the foregoing message includes one or more counter values, and each PSCell may be associated with one or more counter values.

The CPAC configuration may be configured by using an RRC reconfiguration message, and the CPAC configuration may include at least one of the following:
a condition reconfiguration; or
an execution condition.

The condition reconfiguration includes at least one of the following:
a candidate SCG used for CPAC; or
one or more counter values.

Step 2: The terminal performs evaluation based on the CPAC configuration (such as a CPC configuration), and it is assumed that in this case, a current serving PSCell of the terminal is Cell-1. It is assumed that the candidate PSCell may include Cell2, Cell3, and Cell4. When Cell-2 meets a corresponding condition, CPC is executed.

Step 3: If a CPC configuration associated with Cell-2 includes a counter value 1, the terminal deletes a secondary key (secondary key, including S-KgNB or S-KeNB) that is being used, and calculates a new secondary key based on the counter value.

Step 3.1: If the CPC configuration associated with Cell-2 includes no counter value, the UE continues to use the current secondary key.

Step 4: If a radio bearer of the terminal is configured to use the secondary key, the terminal encrypts and/or performs integrity protection on the bearer by using the secondary key calculated in step 3 or 3.1 and/or an RRC key and/or a user plane (UP) key that are/is further derived from the secondary key.

Step 5: The terminal does not delete the CPC configuration, and continues to perform evaluation based on the CPC configuration, and the PSCell changes to Cell-3. Similar to step 3, the secondary key may be updated.

Step 6: If the terminal finds through evaluation that Cell-2 meets a CPC condition again, the terminal performs a PSCell change process to change PSCell to Cell-2.

Step 7: In this case, after the terminal finds through evaluation that the PSCell changes to Cell-2, there may be the following several possibilities:

Method 1: Assuming that in a CPC configuration (such as condRRCReconfig) stored in the terminal and associated with Cell-2, Cell-2 is associated with a plurality of counter values, the terminal uses a new counter value different from that in step 3, and calculates a secondary key (secondary key, including S-KgNB or S-KeNB) based on the counter value.

Method 2: A primary key instead of a secondary key is used for all bearers of PSCell-2, that is, the bearers change to MN-terminated SCG bearers.

Step 8: Optionally, for Cell-2, secure activation time can only be obtained after a random access request of the terminal is received. In addition, Cell-2 needs to determine, based on a ranking at which the terminal accesses the cell, which key to use to communicate with the terminal, and the ranking at which the terminal accesses the cell may be obtained by the SN based on an ID of the UE or based on an additional indication of the UE or the MN.

Step 9: Assuming that all counter values associated with Cell-2 have been used, the terminal deletes a CPC configuration related to the PSCell or deletes the PSCell from the candidate cell, that is, this cell does not participate in evaluation. A configuration may be deleted during a change from another PSCell to PSCell-2, during a change from PSCell-2 to another PSCell, or when PSCell-2 is released.

Step 9-1: (Network side behavior): Optionally, for the SN, if all secondary keys associated with the terminal have been used, the SN releases context of the terminal, and releases a connection to the MN and/or the UE. Otherwise, the SN needs to maintain the context of the terminal and maintain the connection to the MN.

### Embodiment 2

This embodiment is described by using an example in which CPC is executed and counter values are sequentially used and deleted.

Steps 1 to 4 are the same as those in Embodiment 1.

Step 5: In a process of performing a PSCell change and in a period of time after the PSCell change is completed, the terminal reserves at least a CPC configuration associated with Cell-2, but deletes, from a plurality of counter values in the CPC configuration associated with Cell-2, a counter value 1 and/or a secondary key derived based on the counter value 1 and continues evaluation based on a reserved CPC configuration. When Cell-3 meets a CPC execution condition, the terminal changes the PSCell to Cell-3. Similar to step 3, the secondary key may be updated. Similarly, the terminal reserves at least a CPC configuration associated with Cell-2 and continues to perform evaluation based on the reserved CPC configuration.

Further, in this embodiment, the terminal may delete the secondary key based on a local variable. Each time after a secondary key is used, the used secondary key is deleted. A latest key is used each time.

In an example, a specific deletion-related procedure may be as follows:

The terminal receives a reconfiguration message from the base station, and the message includes N counter values. The terminal locally maintains a variable with a variable name being, for example, VarCondReconfigKeyList. The terminal stores the N counter values or a secondary key calculated based on the N counter values. The terminal may generate one such variable for each PSCell or use one variable for all PSCells. Then, when the terminal executes CPC for the first time, it is assumed that a secondary key 1 derived based on the counter value 1 is used. After the secondary key 1 is used, the counter value 1 in the variable or the secondary key 1 calculated based on the counter value 1 is deleted, and a new secondary key is used when CPC is executed subsequently.

Specifically, the terminal may delete the secondary key after executing CPAC; or after random access is initiated for the target PSCell, it is deemed that the key has been used, and therefore, the key is deleted, regardless of whether the random access succeeds or fails; or the secondary key is deleted after CPAC is executed and access succeeds.

Steps 6 to 8 are the same as those in Embodiment 1.

Step 9: If there is no associated counter value for PSCell-2, the terminal deletes a CPC configuration related to the PSCell or deletes the PSCell from candidate cells, that is, this cell does not participate in evaluation. A configuration may be deleted during a change from another PSCell to PSCell-2, during a change from PSCell-2 to another PSCell, or when PSCell-2 is released.

Step 9-1: (Network side behavior): Optionally, for the SN, if all secondary keys associated with the terminal have been used, the SN releases context of the terminal, and releases a connection to the MIN and/or the terminal. Otherwise, the SN needs to maintain the context of the terminal and/or maintain the connection to the MN and/or the UE.

That the SN releases the connection to the MIN and/or the terminal UE may be indicated by the MN, for example, by using an SN_RELEAE_REQUEST message. The MN may also instruct the SN to add a CPAC candidate cell again, and then the MN sends a corresponding configuration to the UE, mainly to supplement a counter value.

### Embodiment 3

In this embodiment, CPA+CPC is used as an example for description.

Step 1: Same as that in Embodiment 1.

Step 2: If the current terminal has no PSCell, the terminal may execute CPA, and after PSCell-1 meets a condition, the terminal adds PSCell-1 and calculates a secondary key by using a corresponding counter value. Then, the terminal continues to evaluate CPC. For PSCell-1, both CPA and CPC may be configured. In this case, after PSCell-1 is added, PSCell-1 may be changed to PSCell-2, and then subsequently changes to PSCell-1 again.

Steps 3 to 5: Same as steps 7 to 9 in Embodiment 1 or Embodiment 2 after PSCell-1 is changed to.

### Embodiment 4

In this embodiment, CPA+CPA is used as an example for description.

Step 1: Same as that in Embodiment 1.

Step 2: If the current terminal has no PSCell, the terminal may execute CPA, and after Cell-1 meets a condition, the terminal calculates a secondary key by using a corresponding counter value, and the PSCell changes to Cell-1. It is assumed that Cell-1 is subsequently released, for example, by an SN. The terminal continues to evaluate CPA, and Cell-1 may meet a condition again, and then PSCell-1 needs to be added again.

Steps 3 to 5: Same as steps 7 to 9 in Embodiment 1 or Embodiment 2 when PSCell-1 is added again.

### Embodiment 5

In this embodiment, as an example for description, a set of counter values are maintained on a terminal side, and a terminal reports a key-related parameter.

Step 1: Abase station sends a CPC configuration message to a terminal, where for each candidate PSCell, an NIN negotiates with an SN in advance about a security-related configuration. Optionally, the CPC configuration includes a counter value.

Optionally, the MN may indicate, in the configuration, a maximum quantity of times of changing a PSCell, or a maximum quantity of times of using the counter value or a maximum value of the counter value.

Step 2: The terminal performs evaluation based on the CPC configuration, and when the terminal is to change to a new PSCell, the terminal adds 1 or N to the counter value (which may also be referred to as increasing counter by 1 or N) after a new secondary key is calculated for the first time by using a counter value in a CPC configuration of the MN or before a new key is calculated next time. A new secondary key is calculated based on a new counter value in each subsequent time, and the new counter value is reported to the MN, or the MN learns a handover status of the terminal based on UL information reported by the terminal, obtains a latest counter value, and continues to add 1 or N to the counter value. Optionally, only a quantity of times that the terminal executes CPC may be reported. In this case, the MN may add a corresponding value to the counter value to obtain a counter value currently used by the terminal.

Step 3: The MN interacts with the SN based on the counter value reported by the terminal and a target PSCell to change, and sends a new secondary key to the SN.

Step 4: The terminal changes to the target PSCell.

### Embodiment 6

In this embodiment, as an example for description, a set of counter values are maintained on a terminal side, and an MN sends a handover command to a terminal.

Steps 1 to 3: Same as those in Embodiment 5.

Step 4: The base station sends an acknowledgment message to the terminal, and the terminal changes to the target PSCell.

### Embodiment 7

In this embodiment, as an example for, a set of counter values are maintained on a terminal side, and a terminal does not need to report a counter value.

Step 1: Same as that in Embodiment 5.

Step 2: The terminal performs evaluation based on the CPC configuration, and when the UE needs to change to a new PSCell, if a secondary key needs to be updated, at the first time, the UE adds N (N≥1) to a counter value in a CPC configuration on a network side (which may also be referred to as increasing counter by N) after a new secondary key is calculated by using the counter value. A new secondary key is calculated based on a new counter value in each subsequent time, and N continues to be added to the counter value. A to-be-changed SN may also learn, in at least one of a plurality of manners such as agreement in a protocol, a notification of the MN, or reporting by the terminal (for example, a random access message: message-1 or message-A), a counter value or a secondary key currently used by the terminal, to communication with the terminal.

### Embodiment 8

In this embodiment, a new triggering condition of a secondary key update process initiated by an SN is used as an example for description.

Step 1: Abase station sends a CPC configuration message to UE.

Step 2: The terminal performs evaluation based on the CPC configuration and executes CPC after a new PSCell meets a condition.

Step 3: The terminal notifies, in a random access message to the PSCell or another RRC message that is obtained after successful access, a new PSCell of a quantity of times and/or duration of consecutive CPC that has been executed by the terminal.

Step 4: An SN sends a key change indication to an MN based on reporting of the terminal, and requests to update a key of the SN.

This embodiment of this application may be implemented as follows:

Each candidate PSCell is associated with a plurality of counter values. For a same PSCell, a terminal sequentially derives secondary keys (for example, Ksn) by using an associated counter value in a case of repeated access. If all counter values associated with the cell have been used, a configuration of the cell in CPC is deleted.

The terminal maintains a set of counter values. Each time a cell is changed, the counter value is used to calculate a new secondary key.

In a continuous CPAC process, an SN may initiate a secondary key update request to an MN based on duration or a quantity of times of consecutive CPAC executed by a currently accessed terminal.

In this embodiment of this application, a key may be updated in real time, and the key may be normally used in a case of repeatedly switching to a PSCell, so that operations such as encryption and integrity protection can be normally performed during communication between the terminal and the base station.

FIG. 5 is a structural diagram of a cell change processing apparatus according to an embodiment of this application. The apparatus stores a first configuration. As shown in FIG. 5, the cell change processing apparatus 500 includes:
an evaluation module 501, configured to evaluate a first cell based on the first configuration;
a first determining module 502, configured to use the first cell as a target PSCell of a terminal in a case that the first cell meets a first condition; and
a second determining module 503, configured to determine, based on the first configuration, a target key for accessing the target PSCell; where
the first configuration is associated with a candidate PSCell, the candidate PSCell includes the first cell, and the first configuration includes at least one of a conditional primary secondary cell change CPC configuration or a conditional primary secondary cell addition CPA configuration.

Optionally, the first cell is a cell that has been released by the terminal, or the first cell is a cell on which the terminal has camped or a cell that has been accessed by the terminal.

Optionally, before the terminal uses the first cell as the target PSCell of the terminal, the PSCell of the terminal changes from the first cell to another cell; or before the terminal uses the first cell as the target PSCell of the terminal, the terminal releases the first cell used as a PSCell of the terminal.

Optionally, that the terminal uses the first cell as the target PSCell of the terminal includes:
the terminal changes the target PSCell of the terminal to the first cell in a case that the PSCell of the terminal changes from the first cell to another cell; or
the terminal adds the first cell as the target PSCell of the terminal.

Optionally, the target key is a first key, the first key is different from a second key, and the second key is a key used by the terminal for the first cell before the terminal uses the first cell as a target PSCell of the terminal.

Optionally, the first key is a first secondary key, and the second key is a second secondary key; or
the first key is a primary key, and the second key is a secondary key; or
the first key is a secondary key, and the second key is a primary key.

Optionally, the first configuration includes a plurality of counter values associated with the first cell, the first secondary key is a secondary key calculated based on one counter value in the plurality of counter values, and the second secondary key is a secondary key calculated based on another counter value in the plurality of counter values.

Optionally, the first secondary key is a secondary key calculated based on a first counter value in the plurality of counter values, and the second secondary key is a secondary key calculated based on a second counter value in the plurality of counter values. The first counter value is located after the second counter value in a target sequence, and the target sequence is a sequence of the plurality of counter values.

Optionally, the target sequence is an ascending sequence of the plurality of counter values; or
the target sequence is a descending sequence of the plurality of counter values; or
the target sequence is a sequence of the plurality of counter values that is indicated by the first configuration.

Optionally, in a case that the target sequence is the sequence of the plurality of counter values that is indicated by the first configuration, the first configuration carries sequence indication information, and the sequence indication information is used to indicate the target sequence; or
the target sequence is a sequence in which the plurality of counter values are carried in the first configuration.

Optionally, the apparatus further includes at least one of the following:
a first deletion module, configured to delete the first configuration in a case that all counter values in the first configuration have been used; or
a second deletion module, configured to: in a case that all counter values in the first configuration have been used, delete the first cell from the candidate PSCell, or not perform evaluation in terms of the first condition on the first cell.

Optionally, the first configuration further includes a configuration associated with the second cell, and the apparatus further includes:
a third deletion module, configured to delete the configuration associated with the second cell from the first configuration in a case that all counter values associated with the second cell that are included in the first configuration have been used.

Optionally, the apparatus further includes at least one of the following:
a fourth deletion module, configured to delete a counter value that has been used from the first configuration; or
a fifth deletion module, configured to delete a secondary key that has been used.

Optionally, the fifth deletion module is configured to remove the secondary key that has been used from a local variable, and the local variable is a local variable corresponding to the first configuration.

Optionally, the first configuration includes a first counter value associated with the first cell, the first secondary key is a secondary key calculated based on a second counter value, the second counter value is a counter value obtained by adding M to a counter value corresponding to the second secondary key, and the counter value corresponding to the second secondary key includes:
the first counter value, or a counter value obtained after adding N to the first counter value; where
M is an integer greater than or equal to 0, and N is an integer greater than or equal to 1.

Optionally, in a case that the first secondary key is the secondary key calculated based on the second counter value, the apparatus further includes:
a first reporting module, configured to report at least one of the following to a network node:
the second counter value or the secondary key calculated based on the second counter value;
a quantity of times of using the first cell as the PSCell based on the first configuration; or
a quantity of times of performing a conditional primary secondary cell addition or change CPAC process based on the first configuration.

Optionally, the apparatus further includes:
a second reporting module, configured to report notification information to the network node, where the notification information includes at least one of the following:
a quantity of times that the terminal performs the CPAC process for the first cell;
duration of the CPAC process performed by the terminal for the first cell;
a quantity of times of performing the CPAC process based on the first configuration; or
duration of the CPAC process performed based on the first configuration.

Optionally, the second reporting module is configured to report the notification information to the network node in a random access message or a radio resource control RRC message.

The cell change processing apparatus can reduce configuration overheads.

The cell change processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the types of terminals listed in this embodiment of this application, and the another device may be a server, a network attached storage (NAS), or the like. This is not specifically limited in this embodiment of this application.

The cell change processing apparatus provided in this embodiment of this application can implement the processes implemented in the method embodiment shown in FIG. 2, and achieve a same technical effect. To avoid repetition, details are not provided herein again.

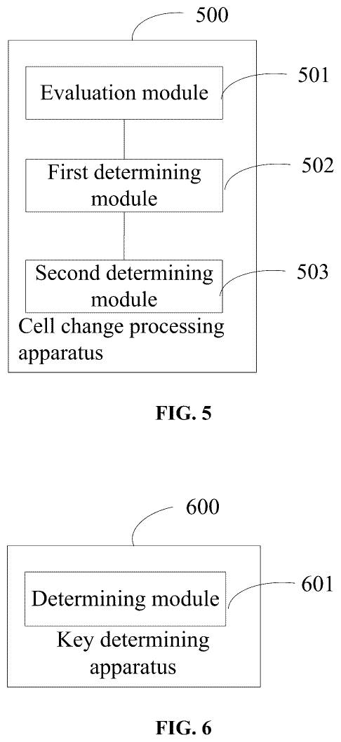

FIG. 6 is a structural diagram of a key determining apparatus according to an embodiment of this application. As shown in FIG. 6, the key determining apparatus 600 includes: a determining module 601, configured to determine, based on target information, a
target key currently used for and/or to be used for a first cell, where the first cell is a primary secondary cell PSCell of a terminal.

The target information includes at least one of the following:
indication information of a master node MN; or
information carried when the terminal performs random access.

Optionally, the apparatus further includes:
a releasing module, configured to release at least one of the following in a case that there is still an unused target key in keys associated with the terminal:
context of the terminal;
a connection to a master node MN of the terminal; or
a connection to the terminal; and
a maintaining module, configured to maintain at least one of the following in a case that there is still an unused target key in keys associated with the terminal:
context of the terminal;
a connection to an MN of the terminal; or
a connection to the terminal.

Optionally, the indication information of the MN includes:
the target key, where the target key is a key calculated by the MN based on reported information of the terminal; or
a key carried in the reported information of the terminal.

Optionally, the reported information of the terminal includes at least one of the following:
a second counter value or a secondary key calculated based on the second counter value, where the second counter value is a counter value calculated by the terminal based on a first counter value included in a first configuration, the first configuration is associated with a candidate PSCell, and the first configuration includes at least one of a conditional primary secondary cell change CPC configuration or a conditional primary secondary cell addition CPA configuration;
a quantity of times that the terminal uses the first cell as the PSCell based on the first configuration; or
a quantity of times that the terminal performs a conditional primary secondary cell addition or change CPAC process based on the first configuration.

Optionally, the apparatus further includes:
a first receiving module, configured to receive notification information reported by the terminal; and
a sending module, configured to send a key change indication to the MN of the terminal based on the notification information; where
the notification information includes at least one of the following:
a quantity of times that the terminal performs the CPAC process for the first cell;
duration of the CPAC process performed by the terminal for the first cell;
a quantity of times of performing the CPAC process based on the first configuration; or
duration of the CPAC process performed by the terminal based on the first configuration.

Optionally, the target key is a first key, the first key is different from a second key, and the second key is a key used by the SN for the first cell before the SN the first cell as a target PSCell of the terminal.

Optionally, the first key is a first secondary key, and the second key is a second secondary key; or
the first key is a primary key, and the second key is a secondary key; or
the first key is a secondary key, and the second key is a primary key.

Optionally, the apparatus further includes a second receiving module, configured to receive a configuration that is sent by the MN and that includes a plurality of counter values or a plurality of keys associated with the first cell.

Optionally, the first secondary key and the second secondary key are keys in the plurality of keys; and
the first secondary key is located after the second secondary key in a target sequence, and the target sequence is a sequence of the plurality of keys.

Optionally, the target sequence is an ascending sequence of the plurality of keys; or
the target sequence is a descending sequence of the plurality of keys; or
the target sequence is a sequence of the plurality of keys that is indicated by the configuration.

Optionally, in a case that the target sequence is the sequence of the plurality of keys that is indicated by the configuration,
the configuration carries sequence indication information, and the sequence indication information is used to indicate the target sequence; or
the target sequence is a sequence in which the plurality of key are carried in the configuration.

The key determining apparatus can reduce configuration overheads.

The key determining apparatus in this embodiment of this application may be an electronic device, for example, an electronic device with an operating system, or may be a component in the electronic device, for example, an integrated circuit or a chip. The electronic device may be a network side device, or may be another device except the network side device. For example, the network side device may include but is not limited to the types of network side devices listed in this embodiment of this application, and the another device may be a server, a network attached storage (NAS), or the like. This is not specifically limited in this embodiment of this application.

The key determining apparatus provided in this embodiment of this application can implement the processes implemented in the method embodiment shown in FIG. 3, and achieve a same technical effect. To avoid repetition, details are not provided herein again.

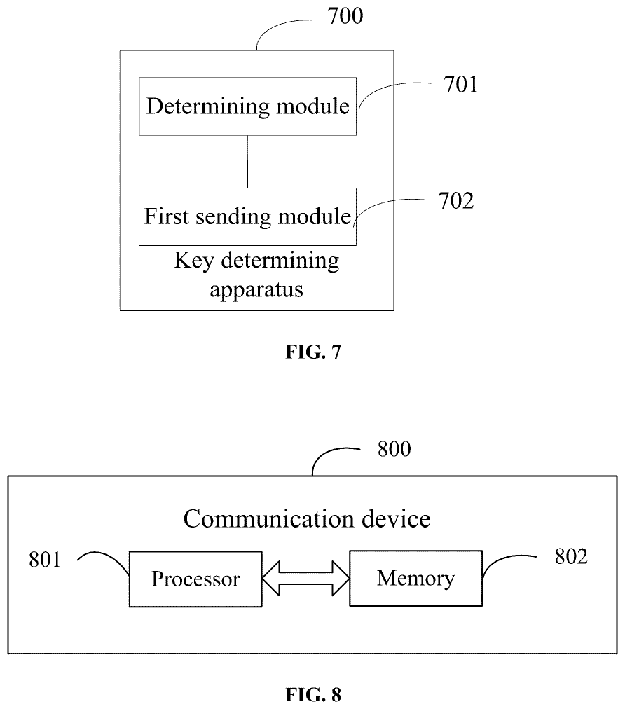

FIG. 7 is a structural diagram of another key determining apparatus according another to an embodiment of this application. As shown in FIG. 7, the key determining apparatus 700 includes:
a determining module 701, configured to determine a target key currently used for and/or to be used for a first cell, where the first cell is a primary secondary cell PSCell of a terminal; and
a first sending module 702, configured to send the target key to a secondary node SN.

Optionally, the apparatus further includes:
a second sending module, configured to send a first configuration to the terminal, where the first configuration includes at least one of the following:
a plurality of counter values corresponding to a plurality of target keys; or
first counter values corresponding to one or more target keys; where
the plurality of target keys are a plurality of target keys that are determined by the NIN and that are used by the terminal for the first cell; and
the first configuration is associated with a candidate PSCell, and the first configuration includes at least one of a conditional primary secondary cell change CPC configuration or a conditional primary secondary cell addition CPA configuration.

Optionally, the determining module 701 is configured to: calculate, based on reported information of the terminal, the target key currently used for the first cell; or
obtain the target key from the reported information of the terminal.

Optionally, the reported information of the terminal includes at least one of the following:
a second counter value or a secondary key calculated based on the second counter value, where the second counter value is a counter value calculated by the terminal based on a first counter value includes in the first configuration, the first configuration is associated with a candidate PSCell, and the first configuration includes at least one of a conditional primary secondary cell change CPC configuration or a conditional primary secondary cell addition CPA configuration;
a quantity of times that the terminal uses the first cell as a PSCell based on the first configuration; or
a quantity of times that the terminal performs a conditional primary secondary cell addition or change CPAC process based on the first configuration.

The key determining apparatus can reduce configuration overheads.

The key determining apparatus in this embodiment of this application may be an electronic device, for example, an electronic device with an operating system, or may be a component in the electronic device, for example, an integrated circuit or a chip. The electronic device may be a network side device, or may be another device except a terminal. For example, the network side device may include but is not limited to the types of network side devices listed in this embodiment of this application, and the another device may be a server, a network attached storage (NAS), or the like. This is not specifically limited in this embodiment of this application.

The key determining apparatus provided in this embodiment of this application can implement the processes implemented in the method embodiment shown in FIG. 4, and achieve a same technical effect. To avoid repetition, details are not provided herein again.

Optionally, as shown in FIG. 8, an embodiment of this application further provides a communication device 800, including a processor 801 and a memory 802, and the memory 802 stores a program or an instruction that can be run on the processor 801. For example, in a case that the communication device 800 is a terminal, when the program or the instruction is executed by the processor 801, the steps of the foregoing embodiment of the cell change processing method on the terminal side are implemented, and a same technical effect can be achieved. In a case that the communication device 800 is an SN, when the program or the instruction is executed by the processor 801, the steps of the foregoing embodiment of the key determining method on the SN side are implemented, and a same technical effect can be achieved. In a case that the communication device 800 is an MN, when the program or the instruction is executed by the processor 801, the steps of the foregoing embodiment of the key determining method on the MN side are implemented, and a same technical effect can be achieved. To avoid repetition, details are not described herein again.

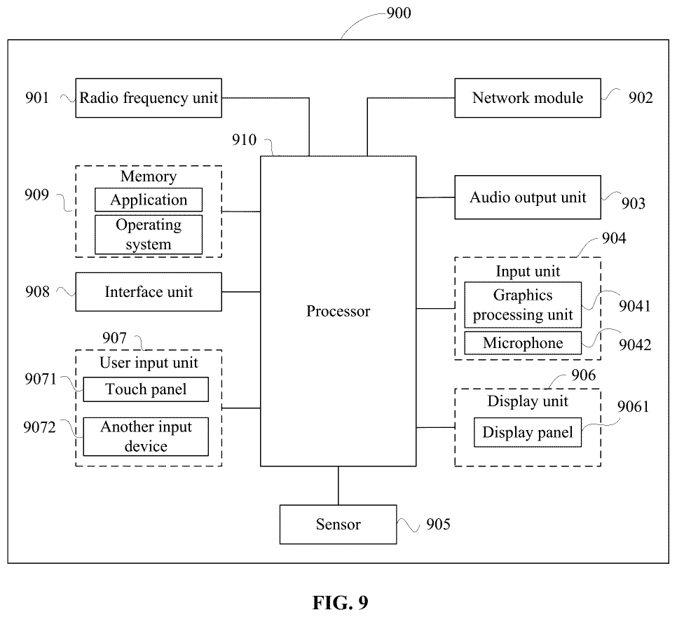

An embodiment of this application further provides a terminal, including a processor and a communication interface. The processor is configured to: evaluate a first cell based on a first configuration; use the first cell as a target PSCell of the terminal in a case that the first cell meets a first condition; and determine, based on the first configuration, a target key for accessing the target PSCell. The first configuration is associated with a candidate PSCell, the candidate PSCell includes the first cell, and the first condition includes at least one of a conditional primary secondary cell change CPC configuration or a conditional primary secondary cell addition CPA configuration. The terminal embodiment is corresponding to the terminal side method embodiment, each implementation process and implementation of the method embodiment can be applied to the terminal embodiment, and a same technical effect can be achieved. Specifically, FIG. 9 is a schematic diagram of a hardware structure of a terminal according to an embodiment of this application.

The terminal 900 includes but is not limited to at least some of components such as a radio frequency unit 901, a network module 902, an audio output unit 903, an input unit 904, a sensor 905, a display unit 906, a user input unit 907, an interface unit 908, a memory 909, and a processor 910.

A person skilled in the art may understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that, in this embodiment of this application, the input unit 904 may include a graphics processing unit (GPU) 9041 and a microphone 9042, and the graphics processing unit 9041 processes image data of a still picture or a video obtained by an image capture apparatus (such as a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/offbutton), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Generally, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may be a volatile memory or a non-volatile memory, or the memory 909 may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 909 in this embodiment of this application includes but is not limited to these memories and any memory of another proper type.

The processor 910 may include one or more processing units. Optionally, an application processor and a modem processor are integrated into the processor 910. The application processor mainly processes an operating system, a user interface, an application, or the like. The modem processor mainly processes a wireless communication signal, for example, a baseband processor. It may be understood that, alternatively, the modem processor may not be integrated into the processor 910.

The processor 910 is configured to: evaluate a first cell based on a first configuration; use the first cell as a target PSCell of the terminal in a case that the first cell meets a first condition; and determine, based on the first configuration, a target key for accessing the target PSCell. The first configuration is associated with a candidate PSCell, the candidate PSCell includes the first cell, and the first condition includes at least one of a conditional primary secondary cell change CPC configuration or a conditional primary secondary cell addition CPA configuration.

Optionally, the first cell is a cell that has been released by the terminal, or the first cell is a cell on which the terminal has camped or a cell that has been accessed by the terminal.

Optionally, before the terminal uses the first cell as the target PSCell of the terminal, the PSCell of the terminal changes from the first cell to another cell; or
before the terminal uses the first cell as the target PSCell of the terminal, the terminal releases the first cell used as a PSCell of the terminal.

Optionally, that the terminal uses the first cell as the target PSCell of the terminal includes:
the terminal changes the target PSCell of the terminal to the first cell in a case that the PSCell of the terminal changes from the first cell to another cell; or
the terminal adds the first cell as the target PSCell of the terminal.

Optionally, the target key is a first key, the first key is different from a second key, and the second key is a key used by the terminal for the first cell before the terminal uses the first cell as a target PSCell of the terminal.

Optionally, the first key is a first secondary key, and the second key is a second secondary key; or
the first key is a primary key, and the second key is a secondary key; or
the first key is a secondary key, and the second key is a primary key.

Optionally, the first configuration includes a plurality of counter values associated with the first cell, the first secondary key is a secondary key calculated based on one counter value in the plurality of counter values, and the second secondary key is a secondary key calculated based on another counter value in the plurality of counter values.

Optionally, the first secondary key is a secondary key calculated based on a first counter value in the plurality of counter values, and the second secondary key is a secondary key calculated based on a second counter value in the plurality of counter values. The first counter value is located after the second counter value in a target sequence, and the target sequence is a sequence of the plurality of counter values.

Optionally, the target sequence is an ascending sequence of the plurality of counter values; or
the target sequence is a descending sequence of the plurality of counter values; or
the target sequence is a sequence of the plurality of counter values that is indicated by the first configuration.

Optionally, in a case that the target sequence is the sequence of the plurality of counter values that is indicated by the first configuration,
the first configuration carries sequence indication information, and the sequence indication information is used to indicate the target sequence; or
the target sequence is a sequence in which the plurality of counter values are carried in the first configuration.

Optionally, the processor 910 is further configured to perform at least one of the following:
deleting the first configuration in a case that all counter values in the first configuration have been used; or
in a case that all counter values in the first configuration have been used, deleting the first cell from the candidate PSCell, or skipping, by the terminal, evaluation in terms of the first condition on the first cell.

Optionally, the first configuration further includes a configuration associated with the second cell, and the processor 910 is further configured to:
delete the configuration associated with the second cell from the first configuration in a case that all counter values associated with the second cell that are included in the first configuration have been used.

Optionally, the processor 910 is further configured to perform at least one of the following:
deleting a counter value that has been used from the first configuration; or
deleting a secondary key that has been used.

Optionally, the deleting a secondary key that has been used includes:
removing the secondary key that has been used from a local variable, where the local variable is a local variable corresponding to the first configuration.

Optionally, the first configuration includes a first counter value associated with the first cell, the first secondary key is a secondary key calculated based on a second counter value, the second counter value is a counter value obtained by adding M to a counter value corresponding to the second secondary key, and the counter value corresponding to the second secondary key includes:
the first counter value, or a counter value obtained after adding N to the first counter value; where
M is an integer greater than or equal to 0, and N is an integer greater than or equal to 1.

Optionally, in a case that the first secondary key is a secondary key calculated based on the second counter value, the radio frequency unit 901 is configured to:
report at least one of the following to a network node:
the second counter value or the secondary key calculated based on the second counter value;
a quantity of times of using the first cell as the PSCell based on the first configuration; or
a quantity of times of performing a conditional primary secondary cell addition or change CPAC process based on the first configuration.

Optionally, the radio frequency unit 901 is configured to:
report notification information to the network node, where the notification information includes at least one of the following:
a quantity of times that the terminal performs the CPAC process for the first cell;
duration of the CPAC process performed by the terminal for the first cell;
a quantity of times of performing the CPAC process based on the first configuration; or
duration of the CPAC process performed based on the first configuration.

Optionally, the second reporting module is configured to report the notification information to the network node in a random access message or a radio resource control RRC message.

The foregoing terminal can reduce configuration overheads.

An embodiment of this application further provides a network node, including a processor and a communication interface. In a case that the network node is an SN, the processor is configured to determine, based on target information, a target key currently used for and/or to be used for a first cell. The first cell is a primary secondary cell PSCell of a terminal, and the target information includes at least one of the following: indication information of a master node NIN, or information carried when the terminal performs random access. In a case that the network node is an MN, the processor is configured to determine a target key currently used for and/or to be used for a first cell, where the first cell is a primary secondary cell PSCell of the terminal; and the communication interface is configured to send the target key to a secondary node SN. This embodiment of the network node is corresponding to the foregoing method embodiments of the SN and the MN. Each implementation process and implementation of the foregoing method embodiment may be applicable to this embodiment of the network side device, and a same technical effect can be achieved.

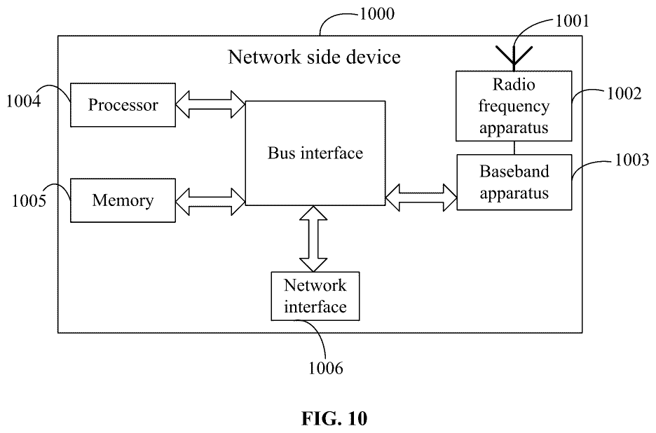

Specifically, an embodiment of this application further provides a network node. As shown in FIG. 10, the network node 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information by using the antenna 1001, and sends the received information to the baseband apparatus 1003 for processing. In a downlink direction, the baseband apparatus 1003 processes information that needs to be sent, and sends processed information to the radio frequency apparatus 1002. The radio frequency apparatus 1002 processes the received information, and sends processed information by using the antenna 1001.

In the foregoing embodiment, a method performed by the network node may be implemented in the baseband apparatus 1003. The baseband apparatus 1003 includes a baseband processor.

For example, the baseband apparatus 1003 may include at least one baseband board. A plurality of chips are disposed on the baseband board. As shown in FIG. 10, one chip is, for example, a baseband processor, and is connected to the memory 1005 by using a bus interface, to invoke a program in the memory 1005 to perform the operations of the network device shown in the foregoing method embodiment.

The network node may further include a network interface 1006, and the interface is, for example, a common public radio interface (CPRI).

Specifically, the network node 1000 in this embodiment of the present invention further includes a program or an instruction that is stored in the memory 1005 and that can be run on the processor 1004, and the processor 1004 invokes the program or the instruction in the memory 1005 to perform the method performed by the modules shown in FIG. 3, and a same technical effect is achieved. To avoid repetition, details are not described herein again.

In a case that the network node is an SN, the processor 1004 is configured to determine, based on target information, a target key currently used for and/or to be used for a first cell, where the first cell is a primary secondary cell PSCell of a terminal.

The target information includes at least one of the following:
indication information of a master node MN; or
information carried when the terminal performs random access.

Optionally, the processor 1004 is further configured to:
release at least one of the following in a case that all target keys associated with the terminal have been used:
context of the terminal;
a connection to a master node MN of the terminal; or
a connection to the terminal; and
maintain at least one of the following in a case that there is still an unused target key in keys associated with the terminal:
context of the terminal;
a connection to an MN of the terminal; or
a connection to the terminal.

Optionally, the indication information of the MN includes:
the target key, where the target key is a key calculated by the MN based on reported information of the terminal; or
a key carried in the reported information of the terminal.

Optionally, the reported information of the terminal includes at least one of the following:
a second counter value or a secondary key calculated based on the second counter value, where the second counter value is a counter value calculated by the terminal based on a first counter value included in a first configuration, the first configuration is associated with a candidate PSCell, and the first configuration includes at least one of a conditional primary secondary cell change CPC configuration or a conditional primary secondary cell addition CPA configuration;
a quantity of times that the terminal uses the first cell as the PSCell based on the first configuration; or
a quantity of times that the terminal performs a conditional primary secondary cell addition or change CPAC process based on the first configuration.

Optionally, the radio frequency apparatus 1002 is configured to:
receive notification information reported by the terminal; and
sending a key change indication to the MN of the terminal based on the notification information; where
the notification information includes at least one of the following:
a quantity of times that the terminal performs the CPAC process for the first cell;
duration of the CPAC process performed by the terminal for the first cell;
a quantity of times of performing the CPAC process based on the first configuration; or
duration of the CPAC process performed by the terminal based on the first configuration.

Optionally, the target key is a first key, the first key is different from a second key, and the second key is a key used by the SN for the first cell before the SN the first cell as a target PSCell of the terminal.

Optionally, the first key is a first secondary key, and the second key is a second secondary key; or
the first key is a primary key, and the second key is a secondary key; or
the first key is a secondary key, and the second key is a primary key.

Optionally, the radio frequency apparatus 1002 is further configured to:
receive a configuration that is sent by the MN and that includes a plurality of counter values or a plurality of keys associated with the first cell.

Optionally, the first secondary key and the second secondary key are keys in the plurality of keys; and
the first secondary key is located after the second secondary key in a target sequence, and the target sequence is a sequence of the plurality of keys.

Optionally, the target sequence is an ascending sequence of the plurality of keys; or
the target sequence is a descending sequence of the plurality of keys; or
the target sequence is a sequence of the plurality of keys that is indicated by the configuration.

Optionally, in a case that the target sequence is the sequence of the plurality of keys that is indicated by the configuration,
the configuration carries sequence indication information, and the sequence indication information is used to indicate the target sequence; or
the target sequence is a sequence in which the plurality of key are carried in the configuration.

The foregoing SN can reduce configuration overheads.

In a case that the network node is an MN, the processor 1004 is configured to determine a target key currently used for and/or to be used for a first cell, where the first cell is a primary secondary cell PSCell of the terminal.

The radio frequency apparatus 1002 is configured to send the target key to a secondary node SN.

Optionally, the radio frequency apparatus 1002 is further configured to:
send a first configuration to the terminal, where the first configuration includes at least one of the following:
a plurality of counter values corresponding to a plurality of target keys; or
first counter values corresponding to one or more target keys; where
the plurality of target keys are a plurality of target keys that are determined by the NIN and that are used by the terminal for the first cell; and
the first configuration is associated with a candidate PSCell, and the first configuration includes at least one of a conditional primary secondary cell change CPC configuration or a conditional primary secondary cell addition CPA configuration.

Optionally, the determining a target key currently used for and/or to be used for a first cell includes:
calculating, based on reported information of the terminal, the target key currently be used for the first cell; or
obtaining the target key from the reported information of the terminal.

Optionally, the reported information of the terminal includes at least one of the following:
a second counter value or a secondary key calculated based on the second counter value, where the second counter value is a counter value calculated by the terminal based on a first counter value includes in the first configuration, the first configuration is associated with a candidate PSCell, and the first configuration includes at least one of a conditional primary secondary cell change CPC configuration or a conditional primary secondary cell addition CPA configuration;
a quantity of times that the terminal uses the first cell as a PSCell based on the first configuration; or
a quantity of times that the terminal performs a conditional primary secondary cell addition or change CPAC process based on the first configuration.

The foregoing MN can reduce configuration overheads.

An embodiment of this application further provides a readable storage medium. A program or an instruction is stored in the readable storage medium. When the program or the instruction is executed by a processor, the processes of the embodiments of the cell change processing method and the key determining method are implemented, and a same technical effect can be achieved. To avoid repetition, details are not described herein.

The processor is a processor in the terminal in the foregoing embodiment. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the embodiments of the cell change processing method and the key determining method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor, to implement the processes of the embodiments of the cell change processing method and the key determining method, and a same technical effect can be achieved. To avoid repetition, details are not described herein again.

An embodiment of this application further provides a transmission determining system, including a terminal, an SN, and an MN. The terminal may be configured to perform the steps of the foregoing cell change processing method, the SN may be configured to perform the steps of the key determining method on the SN side, and the MN may be configured to perform the steps of the key determining method on the MN side.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A cell change processing method, wherein a terminal stores a first configuration, and the method comprises:
evaluating, by the terminal, a first cell based on the first configuration;
using, by the terminal, the first cell as a target primary secondary cell (PSCell) of the terminal in a case that the first cell meets a first condition; and
determining, by the terminal based on the first configuration, a target key for accessing the target PSCell; wherein
the first configuration is associated with a candidate PSCell, the candidate PSCell comprises the first cell, and the first configuration comprises at least one of a conditional primary secondary cell change (CPC) configuration or a conditional primary secondary cell addition (CPA) configuration.

2. The method according to claim 1, wherein the first cell is a cell that has been released by the terminal, or the first cell is a cell on which the terminal has previously camped, or a cell that has been accessed by the terminal.

3. The method according to claim 1, wherein before the terminal uses the first cell as the target PSCell of the terminal, a PSCell of the terminal changes from the first cell to another cell; or
before the terminal uses the first cell as the target PSCell of the terminal, the terminal releases the first cell used as a PSCell of the terminal.

4. The method according to claim 3, wherein the using, by the terminal, the first cell as a target PSCell of the terminal comprises:
changing, by the terminal, the target PSCell of the terminal to the first cell in a case that the PSCell of the terminal changes from the first cell to another cell; or
adding, by the terminal, the first cell as the target PSCell of the terminal.

5. The method according to claim 1, wherein the target key is a first key, the first key is different from a second key, and the second key is a key used by the terminal for the first cell before the terminal uses the first cell as the target PSCell of the terminal.

6. The method according to claim 5, wherein the first key is a first secondary key, and the second key is a second secondary key; or
the first key is a primary key, and the second key is a secondary key; or
the first key is a secondary key, and the second key is a primary key.

7. The method according to claim 6, wherein the first configuration comprises a plurality of counter values associated with the first cell, the first secondary key is a secondary key calculated based on one counter value in the plurality of counter values, and the second secondary key is a secondary key calculated based on another counter value in the plurality of counter values.

8. The method according to claim 7, wherein the first secondary key is a secondary key calculated based on a first counter value in the plurality of counter values, and the second secondary key is a secondary key calculated based on a second counter value in the plurality of counter values, wherein the first counter value is located after the second counter value in a target sequence, and the target sequence is a sequence of the plurality of counter values.

9. The method according to claim 8, wherein the target sequence is an ascending sequence of the plurality of counter values; or
the target sequence is a descending sequence of the plurality of counter values; or
the target sequence is a sequence of the plurality of counter values that is indicated by the first configuration.

10. The method according to claim 9, wherein in a case that the target sequence is the sequence of the plurality of counter values that is indicated by the first configuration,
the first configuration carries sequence indication information, and the sequence indication information is used to indicate the target sequence; or
the target sequence is a sequence in which the plurality of counter values are carried in the first configuration.

11. The method according to claim 7, wherein the method further comprises at least one of the following:
deleting, by the terminal, the first configuration in a case that all counter values in the first configuration have been used; or
in a case that all counter values in the first configuration have been used, deleting, by the terminal, the first cell from the candidate PSCell, or skipping, by the terminal, evaluation in terms of the first condition on the first cell.

12. The method according to claim 7, wherein the first configuration further comprises a configuration associated with a second cell, and the method further comprises:
deleting, by the terminal, the configuration associated with the second cell from the first configuration in a case that all counter values associated with the second cell that are comprised in the first configuration have been used.

13. The method according to claim 7, wherein the method further comprises at least one of the following: deleting, by the terminal, a counter value that has been used from the first configuration; or
deleting, by the terminal, a secondary key that has been used;
wherein the deleting, by the terminal, a secondary key that has been used comprises:
removing, by the terminal, the secondary key that has been used from a local variable, wherein the local variable is a local variable corresponding to the first configuration.

14. The method according to claim 6, wherein the first configuration comprises a first counter value associated with the first cell, the first secondary key is a secondary key calculated based on a second counter value, the second counter value is a counter value obtained after adding M to a counter value corresponding to the second secondary key, and the counter value corresponding to the second secondary key comprises:
the first counter value, or a counter value obtained after adding N to the first counter value; wherein
M is an integer greater than or equal to 0, and N is an integer greater than or equal to 1;
wherein in a case that the first secondary key is the secondary key calculated based on the second counter value, the method further comprises:
reporting, by the terminal, at least one of the following to a network node:
the second counter value or the secondary key calculated based on the second counter value;
a quantity of times of using the first cell as the PSCell based on the first configuration; or
a quantity of times of performing a conditional primary secondary cell addition or change (CPAC) process based on the first configuration.

15. The method according to claim 1, wherein the method further comprises:
reporting, by the terminal, notification information to the network node, wherein the notification information comprises at least one of the following:
a quantity of times that the terminal performs the CPAC process for the first cell;
duration of the CPAC process performed by the terminal for the first cell;
a quantity of times of performing the CPAC process based on the first configuration; or
duration of the CPAC process performed based on the first configuration;
wherein the reporting, by the terminal, notification information to the network node comprises:
reporting, by the terminal, the notification information to the network node in a random access message or a radio resource control (RRC) message.

16. A key determining method, comprising:
determining, by a secondary node (SN) based on target information, a target key currently used for and/or to be used for a first cell, wherein the first cell is a primary secondary cell (PSCell) of a terminal; wherein
the target information comprises at least one of the following:
indication information of a master node (MN); or
information carried when the terminal performs random access.

17. A key determining method, comprising:
determining, by a master node (MN), a target key currently used for and/or to be used for a first cell, wherein the first cell is a primary secondary cell (PSCell) of a terminal; and
sending, by the MN, the target key to a secondary node (SN).

18. A terminal, comprising a processor and a memory, wherein the memory stores a program or an instruction that can be run on the processor, and when the program or the instruction is executed by the processor, the steps of the cell change processing method according to claim 1 are implemented.

19. A network node, wherein the network node is a secondary node (SN) and comprises a processor and a memory, the memory stores a program or an instruction that can be run on the processor, and when the program or the instruction is executed by the processor, the steps of the key determining method according to claim 16 are implemented.

20. A network node, wherein the network node is a master node (MN) and comprises a processor and a memory, the memory stores a program or an instruction that can be run on the processor, and when the program or the instruction is executed by the processor, the steps of the key determining method according to claim 17 are implemented.
